(19) United States
(12) Patent Application Publication
(10) Pub. No.: US 2025/0165901 A1
(43) Pub. Date: May 22, 2025

(54) CARBON QUOTA PROCESSING METHOD, SYSTEM AND STORAGE MEDIA

(71) Applicant: JIANGSU XCMG CONSTRUCTION MACHINERY RESEARCH INSTITUTE LTD., Xuzhou (CN)

(72) Inventors: Guangcun WANG, Xuzhou (CN); Xiujie XU, Xuzhou (CN); Zhijun LU, Xuzhou (CN)

(21) Appl. No.: 18/953,660

(22) Filed: Nov. 20, 2024

(30) Foreign Application Priority Data
Nov. 20, 2023 (CN) 202311551416.8

(51) Int. Cl. G06Q 10/067; G06Q 10/0637

(52) U.S. Cl. CPC G06Q 10/067; G06Q 10/06375

(57) ABSTRACT

The present disclosure discloses a carbon quota processing method, system and storage medium, and relates to the technical field of carbon emission control. The method includes: determining a target manufacturing entity and searching for historical carbon inventory data of manufacturing entities within a manufacturing entity set to which the target manufacturing entity belongs; obtaining a carbon emission planning parameter of the target manufacturing entity during a target time period; calculating influencing factors that influence the balance between environmental protection and development of the target manufacturing entity based on the historical carbon inventory data and the carbon emission planning parameter; building a carbon quota allocation model based on the influencing factors; and allocating a carbon quota during the target time period to the target manufacturing entity based on the carbon quota allocation model.

### CROSS-REFERENCE TO RELATED APPLICATIONS

The present application is based on and claims priority to CN patent application Ser. No. 202311551416.8 filed on Nov. 20, 2023, the disclosure of which is incorporated by reference herein in its entirety.

### TECHNICAL FIELD

The present disclosure relates to the technical field of carbon emission control, and more particularly to a carbon quota processing method, a system, and a storage medium.

### BACKGROUND

With the excessive emission of greenhouse gases such as carbon dioxide, extreme weather phenomena such as floods, droughts and sandstorms are becoming more frequent, threatening the survival and development of human society. Governments around the world have adopted mandatory climate policies to reduce greenhouse gas emissions by restricting production and manufacturing by high-polluting companies.

In order to reduce carbon emissions and achieve carbon peaking and carbon neutrality goals, it is necessary to implement a reasonable carbon quota allocation. In the carbon allocation scheme in related technologies, the scheme using the historical intensity decline method takes into account relatively simple factors. For example, an annual decline coefficient is used in its calculation formula, which is only applicable to industries with relatively homogeneous products such as power generation intensities, and is not suitable for the allocation of carbon quotas in complicated mechanical manufacturing industries.

### SUMMARY

According to an aspect of the present disclosure, there is provided a carbon quota processing method, comprising: determining a target manufacturing entity and searching for historical carbon inventory data of manufacturing entities within a manufacturing entity set to which the target manufacturing entity belongs; obtaining a carbon emission planning parameter of the target manufacturing entity during a target time period; calculating influencing factors that influence the balance between environmental protection and development of the target manufacturing entity based on the historical carbon inventory data and the carbon emission planning parameter; building a carbon quota allocation model based on the influencing factors; and allocating a carbon quota during the target time period to the target manufacturing entity based on the carbon quota allocation model.

In some embodiments, obtaining a carbon emission of the target manufacturing entity during the target time period; and sending a prompt message to a client of the target manufacturing entity, in a case where the carbon emission of the target manufacturing entity during the target time period does not match the allocated carbon quota.

In some embodiments, calculating influencing factors that influence the balance between environmental protection and development of the target manufacturing entity comprises: calculating a first carbon emission intensity mean value of the manufacturing entity set corresponding to a historical time period, a second carbon emission intensity mean value of the target manufacturing entity corresponding to the historical time period, a carbon emission change and a gross industrial production change of the target manufacturing entity during a first time period within the historical time period relative to a second time period prior to the first time period, and a type of the target manufacturing entity, based on the historical carbon inventory data; and calculating the influencing factors that influence the balance between environmental protection and development of the target manufacturing entity based on the first carbon emission intensity mean value, the second carbon emission intensity mean value, the carbon emission change, the gross industrial production change, the category of the target manufacturing entity, and the carbon emission planning parameter.

In some embodiments, the influencing factors comprise a development growth factor and at least two of an intensity factor, a type factor, a decoupling factor and a policy factor, wherein building the carbon quota allocation model comprises: determining a periodic decline coefficient based on a product of at least two of the intensity factor, the type factor, the decoupling factor, and the policy factor; determining a gross industrial production value of the manufacturing entity set during the target time period based on a product of an average gross industrial production value of the manufacturing entity set corresponding to the historical time period and the development growth factor; and obtaining the carbon quota allocation model by multiplying the periodic decline coefficient, the gross industrial production value during the target time period, and the second carbon emission intensity mean value.

In some embodiments, calculating a regulation of total carbon emissions factor for the manufacturing entity set, wherein obtaining the carbon quota allocation model further comprises: obtaining the carbon quota allocation model by multiplying the periodic decline coefficient, the gross industrial production value during the target time period, the second carbon emission intensity mean value, and the regulation of total carbon emissions factor.

In some embodiments, calculating the regulation of total carbon emissions factor for the manufacturing entity set comprises: calculating a sum of carbon quotas of the multiple manufacturing entities during the target time period to obtain a total carbon quota allocation of the manufacturing entity set; and obtaining the regulation of total carbon emissions factor based on a ratio of a total carbon emission target value of the manufacturing entity set during the target time period to the total carbon quota allocation of the manufacturing entity set.

In some embodiments, the type of the target manufacturing entity comprises a first type entity, a second type entity, or a third type entity, wherein the carbon emission reduction capacity of the first type entity is greater than that of the second type entity, and the carbon emission reduction capacity of the second type entity is greater than that of the third type entity.

In some embodiments, calculating the intensity factor comprises: setting the intensity factor to a first value in a case where the target manufacturing entity is the first type entity or the second type entity, and the second carbon emission intensity mean value of the target manufacturing entity is greater than the first carbon emission intensity mean value; setting the intensity factor to a second value greater than the first value in a case where the target manufacturing entity is the first type entity or the second type entity, and the second carbon emission intensity mean value of the target manufacturing entity is less than or equal to the first carbon emission intensity mean value; and setting the intensity factor to a third value greater than the second value in a case where the target manufacturing entity is the third type entity.

In some embodiments, calculating the type factor comprises: setting the type factor to a fourth value in a case where the target manufacturing entity is the first type entity; setting the type factor to a fifth value greater than the fourth value in a case where the target manufacturing entity is the second type entity; and setting the type factor to a sixth value greater than the fifth value in a case where the target manufacturing entity is the third type entity.

In some embodiments, calculating the decoupling factor comprises: obtain a first parameter by calculating a ratio of the carbon emission change of the target manufacturing entity during the first time period relative to the second time period to a carbon emission during the second time period; obtain a second parameter by calculating a ratio of a gross industrial production change of the target manufacturing entity during the first time period relative to the second time period to a gross industrial production change during the second time period; determining a decoupling coefficient based on a ratio of the first parameter to the second parameter; and setting the decoupling factor based on the decoupling coefficient.

In some embodiments, setting the decoupling factor comprises: setting the decoupling factor to a seventh value in a case where the decoupling coefficient is less than 0, and the carbon emission change is less than 0, and the gross industrial production change is greater than 0; setting the decoupling factor to an eighth value less than the seventh value, in a case where the decoupling coefficient is greater than or equal to 0 and less than a first threshold value, the carbon emission change is greater than or equal to 0, and the gross industrial production change is greater than 0; setting the decoupling factor to a ninth value less than the eight value, in a case where the decoupling coefficient is greater than a second threshold value, the carbon emission change is less than 0, and the gross industrial production change is less than 0; setting the decoupling factor to a tenth value less than the ninth value, in a case where the decoupling coefficient is greater than the first threshold value and less than the second threshold value, the carbon emission change is greater than 0, and the gross industrial production change is greater than 0; setting the decoupling factor to an eleventh value less than the tenth value, in a case where the decoupling coefficient is greater than the first threshold value and less than the second threshold value, the carbon emission change is less than 0, and the gross industrial production change is less than 0; setting the decoupling factor to a twelfth value less than the eleventh value, in a case where the decoupling coefficient is greater than the second threshold value, the carbon emission change is greater than 0, and the gross industrial production change is greater than 0; setting the decoupling factor to a thirteenth value less than the twelfth value, in a case where the decoupling coefficient is greater than 0 and less than the first threshold value, the carbon emission change is less than 0, and the gross industrial production change is less than 0; and setting the decoupling factor to a fourteenth value less than the thirteenth value, in a case where the decoupling coefficient is less than 0, the carbon emission change is greater than 0, and the gross industrial production change is less than 0.

In some embodiments, calculating the policy factor comprises: determining the policy factor based on a ratio of a carbon emission intensity of the target manufacturing entity during the target time period to a carbon emission intensity during the second time period, in a case that the target manufacturing entity is determined to have a carbon emission goal based on the carbon emission planning parameter; and setting the policy factor to 1, in a case that the target manufacturing entity is determined to not have a carbon emission goal.

In some embodiments, calculating the first carbon emission intensity mean value of the manufacturing entity set corresponding to the historical time period comprises: determining the first carbon emission intensity mean value based on a ratio of a sum of carbon emissions of multiple manufacturing entities in the historical carbon inventory data to a sum of gross industrial production values of the multiple manufacturing entities during the historical time period.

In some embodiments, calculating the second carbon emission intensity mean value of the target manufacturing entity corresponding to the historical time period comprises: determining the second carbon emission intensity mean value based on a ratio of a sum of carbon emissions of the target manufacturing entity during the historical time period in the historical carbon inventory data to a sum of the gross industrial production values of the target manufacturing entity during the historical time period.

According to a further aspect of the present disclosure, there is further provided a carbon quota processing system, comprising: a memory; and a processor coupled to the memory, the processor configured to, based on instructions stored in the memory, carry out a carbon quota processing method, comprising: determining a target manufacturing entity and searching for historical carbon inventory data of manufacturing entities within a manufacturing entity set to which the target manufacturing entity belongs; obtaining a carbon emission planning parameter of the target manufacturing entity during a target time period; calculating influencing factors that influence the balance between environmental protection and development of the target manufacturing entity based on the historical carbon inventory data and the carbon emission planning parameter; building a carbon quota allocation model based on the influencing factors; and allocating a carbon quota during the target time period to the target manufacturing entity based on the carbon quota allocation model.

In some embodiments, the carbon quota processing method, further comprises: obtaining a carbon emission of the target manufacturing entity during the target time period; and sending a prompt message to a client of the target manufacturing entity, in a case where the carbon emission of the target manufacturing entity during the target time period does not match the allocated carbon quota.

In some embodiments, calculating influencing factors that influence the balance between environmental protection and development of the target manufacturing entity comprises: calculating a first carbon emission intensity mean value of the manufacturing entity set corresponding to a historical time period, a second carbon emission intensity mean value of the target manufacturing entity corresponding to the historical time period, a carbon emission change and a gross industrial production change of the target manufacturing entity during a first time period within the historical time period relative to a second time period prior to the first time period, and a type of the target manufacturing entity, based on the historical carbon inventory data; and calculating the influencing factors that influence the balance between environmental protection and development of the target manufacturing entity based on the first carbon emission intensity mean value, the second carbon emission intensity mean value, the carbon emission change, the gross industrial production change, the category of the target manufacturing entity, and the carbon emission planning parameter.

According to a further aspect of the present invention, there is further provided a non-transitory computer readable storage medium having stored thereon computer program instructions that, when executed by a processor, implement the carbon quota processing method described, comprising: determining a target manufacturing entity and searching for historical carbon inventory data of manufacturing entities within a manufacturing entity set to which the target manufacturing entity belongs; obtaining a carbon emission planning parameter of the target manufacturing entity during a target time period; calculating influencing factors that influence the balance between environmental protection and development of the target manufacturing entity based on the historical carbon inventory data and the carbon emission planning parameter; building a carbon quota allocation model based on the influencing factors; and allocating a carbon quota during the target time period to the target manufacturing entity based on the carbon quota allocation model.

In some embodiments, obtaining a carbon emission of the target manufacturing entity during the target time period; and sending a prompt message to a client of the target manufacturing entity, in a case where the carbon emission of the target manufacturing entity during the target time period does not match the allocated carbon quota.

In some embodiments, calculating influencing factors that influence the balance between environmental protection and development of the target manufacturing entity comprises: calculating a first carbon emission intensity mean value of the manufacturing entity set corresponding to a historical time period, a second carbon emission intensity mean value of the target manufacturing entity corresponding to the historical time period, a carbon emission change and a gross industrial production change of the target manufacturing entity during a first time period within the historical time period relative to a second time period prior to the first time period, and a type of the target manufacturing entity, based on the historical carbon inventory data; and calculating the influencing factors that influence the balance between environmental protection and development of the target manufacturing entity based on the first carbon emission intensity mean value, the second carbon emission intensity mean value, the carbon emission change, the gross industrial production change, the category of the target manufacturing entity, and the carbon emission planning parameter.

Other features and advantages of the present invention will become apparent from the following detailed description of exemplary embodiments of the present disclosure with reference to the accompanying drawings.

### BRIEF DESCRIPTION OF THE DRAWINGS

The accompanying drawings, which are incorporated in and constitute a portion of this specification, illustrate embodiments of the present disclosure and, together with the description, serve to explain the principles of the present disclosure.

The present disclosure will be more clearly understood from the following detailed description with reference to the accompanying drawings, in which:

FIG. 1 is a flowchart of a carbon quota processing method according to some embodiments of the present disclosure;

FIG. 2 is a flowchart of a carbon quota processing method according to other embodiments of the present disclosure;

FIG. 3 is a schematic diagram illustrating the correction and assignment of influencing factors in carbon quota processing according to some embodiments of the present disclosure;

FIG. 4 is a structure diagram of a carbon quota processing system according to some embodiments of the present disclosure;

FIG. 5 is a structure diagram of a carbon quota processing system according to other embodiments of the present disclosure;

FIG. 6 is a structure diagram of a carbon quota processing system according to still other embodiments of the present disclosure.

### DETAILED DESCRIPTION

Various exemplary embodiments of the present disclosure will now be described in detail with reference to the accompanying drawings. Notice that, unless otherwise specified, the relative arrangement, numerical expressions and values of the components and steps set forth in these examples do not limit the scope of the invention.

At the same time, it should be understood that, for ease of description, the dimensions of the various parts shown in the drawings are not drawn to actual proportions.

The following description of at least one exemplary embodiment is in fact merely illustrative and is in no way intended as a limitation to the invention, its application or use.

Techniques, methods, and apparatus known to those of ordinary skill in the relevant art may not be discussed in detail, but where appropriate, these techniques, methods, and apparatuses should be considered as part of the specification.

Of all the examples shown and discussed herein, any specific value should be construed as merely illustrative and not as a limitation. Thus, other examples of exemplary embodiments may have different values.

Notice that, similar reference numerals and letters are denoted by the like in the accompanying drawings, and therefore, once an item is defined in a drawing, there is no need for further discussion in the accompanying drawings.

For a clear understanding of the object of the present disclosure, its technical solution and advantages, the present disclosure will be further described in detail below in conjunction with the accompanying drawings and embodiments.

Many countries are now planning and gradually promoting the transition from the dual control of “total energy consumption” and “energy intensity” to the dual control of “total carbon emission” and “carbon emission intensity”, actively coordinating development and emission reduction, accelerating the green transition of economic and social development, and contributing to the high-quality development of these countries. The scientific method of allocating carbon emission quotas is a key link in ensuring that countries, industries, regions and companies can fulfill their emission reduction obligations and achieve the goals of carbon peaking and carbon neutrality.

The actual greenhouse gas emissions in the machinery manufacturing industry are relatively large. Through carbon emission accounting and carbon quota allocation from the bottom to the top, enterprises can understand their own carbon emission status, identify high energy consumption and high emission links and processes, to help enterprises explore their emission reduction potential, and lay a solid foundation for the smooth completion of the further goals of carbon peaking and carbon neutrality of these enterprises.

Existing carbon quota allocation methods in related technologies are not suitable for complex manufacturing enterprises, and the unreasonable allocation of carbon quotas may lead to an imbalance between environmental protection costs and development costs for various manufacturing enterprises.

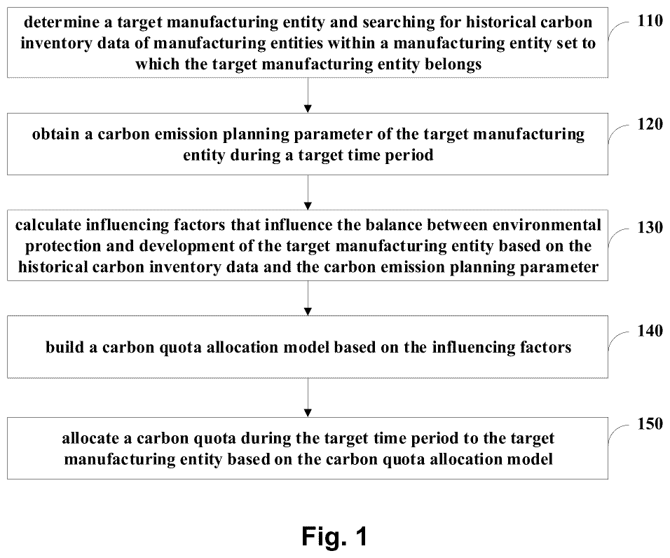

FIG. 1 is a flowchart of a carbon quota processing method according to some embodiments of the present disclosure performed in a carbon quota processing system.

In step 110, a target manufacturing entity is determined and historical carbon inventory data of manufacturing entities within a manufacturing entity set to which the target manufacturing entity belongs is searched.

The manufacturing entity, for example, is a manufacturing enterprise. The manufacturing entity set is, for example, a set of enterprises in a region, a set of enterprises within an industrial park, or a set of enterprises within a group.

In some embodiments, the carbon quota processing system searches a database for historical carbon inventory data of multiple manufacturing entities within a manufacturing entity set to which the target manufacturing entity belongs in response to a carbon quota allocation request sent by the target manufacturing entity.

The historical carbon inventory data comprises each enterprise's carbon emissions in various historical years, gross industrial production values in historical years, and types of enterprises.

In step 120, a carbon emission planning parameter of the target manufacturing entity during a target time period is obtained.

In some embodiments, the target time period is, for example, a target year, and the historical time period is, for example, a few years prior to the target year.

In some embodiments, it can be determined whether the target enterprise has a dual carbon plan, based on the carbon emission planning parameter. If the target enterprise does not have a dual carbon plan, a value related to the carbon emission planning parameter is set to 1.

In step 130, influencing factors that influence the balance between environmental protection and development of the target manufacturing entity are calculated based on the historical carbon inventory data and the carbon emission planning parameter.

In some embodiments, enterprises have different historical carbon emission intensities, different enterprise types, different production processes and emission reduction capacities, the different decoupling states between carbon emissions and economic growth, and different requirements for dual carbon planning. Therefore, the influencing factors that affect the balance of environmental protection and development of enterprises may comprise an intensity factor, a type factor, a decoupling factor, a policy factor, etc.

In some embodiments, a first carbon emission intensity mean value of the manufacturing entity set corresponding to a historical time period, a second carbon emission intensity mean value of the target manufacturing entity corresponding to the historical time period, a carbon emission change and a gross industrial production change of the target manufacturing entity during a first time period within the historical time period relative to a second time period prior to the first time period, and a type of the target manufacturing entity are calculated, based on the historical carbon inventory data; and the influencing factors that influence the balance between environmental protection and development of the target manufacturing entity are calculated based on the first carbon emission intensity mean value, the second carbon emission intensity mean value, the carbon emission change, the gross industrial production change, the category of the target manufacturing entity, and the carbon emission planning parameter.

For example, a carbon emission intensity mean value of the group to which the enterprise belongs in a historical year and a carbon emission intensity mean value of the target enterprise in the historical year are calculated and used to obtain the intensity factor. The last year in historical records is the first time period, which is the current year; the first year in historical records is a base year, which is the second time period; a carbon emission difference between the current year and the benchmark year, as well as a gross industrial production difference between the current year and the base year, are then calculated for the target enterprise, and used to determine the decoupling factor. A type factor is obtained based on the type of enterprise. The policy factor is obtained based on the carbon emission planning parameter.

In step 140, a carbon quota allocation model is built based on the influencing factors.

In some embodiments, a periodic decline coefficient is determined based on a product of at least two of the intensity factor, the type factor, the decoupling factor, and the policy factor; a gross industrial production value of the manufacturing entity set during the target time period is determined based on a product of an average gross industrial production value of the manufacturing entity set corresponding to the historical time period and the development growth factor; the carbon quota allocation model is obtained by multiplying the periodic decline coefficient, the gross industrial production value in the target time period, and the second carbon emission intensity mean value.

In step 150, a carbon quota during the target time period is allocated to the target manufacturing entity based on the carbon quota allocation model.

For example, with the carbon quota allocation model, a carbon quota allocated to the target enterprise can be calculated, and the carbon quota data can be sent to a client of each enterprise, so that each enterprise can improve its equipment parameters or processes based on the carbon quota data to match the carbon emission during the target time period with the carbon quota data.

In the above embodiment, influencing factors affecting the balance between environmental protection and development of the target manufacturing entity are calculated, based on historical carbon inventory data and the carbon emission planning parameter of the target manufacturing entity, and the carbon quota allocation model is constructed. The carbon quota allocation model is used to achieve the carbon quota allocation during the target time period, thereby improving the rationality of the carbon quota allocation for the manufacturing entity, and enabling the manufacturing entity to achieve the balance between environmental protection and development, so that development and growth are achieved on the basis of guaranteeing environmental protection. In addition, through reasonable carbon quota allocation, it can also help enterprises understand their own carbon emission level, accurately identify emission reduction opportunities, and improve their energy conservation and emission reduction capabilities.

In some embodiments, a carbon emission of the target manufacturing entity during the target time period is obtained; a prompt message is sent to a client of the target manufacturing entity, in a case where the carbon emission of the target manufacturing entity during the target time period does not match the allocated carbon quota.

For example, if the carbon emission of a manufacturing enterprise in a target year exceeds the allocated carbon quota, it indicates that the equipment or processes of the manufacturing enterprise has excess carbon emissions and needs to be improved to reduce carbon emissions. The carbon quota processing system sends a prompt message to the target manufacturing entity, making it easy for the target manufacturing entity to promptly identify problems and improve equipment or processes to achieve the carbon reduction goals.

For another example, if the carbon emission of a manufacturing enterprise in the target year is much less than the allocated carbon quota, it indicates that the manufacturing enterprise may have sacrificed its development for carbon reduction. This situation leads to the high cost of carbon reduction for the manufacturing enterprise, and the carbon quota processing system may send a notification message to the target manufacturing entity to facilitate timely adjustment of production planning.

In some embodiments, the first carbon emission intensity mean value is determined based on a ratio of a sum of carbon emissions of multiple manufacturing entities in the historical carbon inventory data to a sum of gross industrial production values of the multiple manufacturing entities in the historical time period.

In some embodiments, the second carbon emission intensity mean value is determined based on a ratio of a sum of carbon emissions of the target manufacturing entity during the historical time period in the historical carbon inventory data to a sum of the gross industrial production values of the target manufacturing entity during the historical time period.

For example, historical carbon inventory data of each enterprise in a group is analyzed, and data from the first 3 to 5 years prior to the target year is selected, with the first year as the base year. From Table 1, the gross industrial production value and carbon emission in each year are collected for each enterprise, and a carbon emission intensity is calculated to further obtain an average carbon emission intensity of each enterprise in each historical year.

TABLE 1
historical carbon inventory data

| Enterprise | Gross industrial | Carbon | Carbon emission |
|---|---|---|---|
| Name | production | emission | intensity |
| Enterprise 1 | | | |
| Enterprise 2 | | | |
| . . . | | | |
| Enterprise N | | | |
| Group | | | |

Carbon emission intensity=Carbon emission/Gross industrial production, wherein the average carbon emission intensity of each enterprise is the average value of carbon emission intensities in the historical years, and the average carbon emission intensity of the group is the average value of the ratios of carbon emissions of multiple enterprises in historical years to the total gross industrial production.

In this embodiment, the historical carbon inventory data is analyzed to ensure that the enterprises have a scientific basis for the allocation of carbon quotas.

The scientific and accurate carbon emission allocation technique is a prerequisite for the manufacturing entity set to obtain accurate carbon emission information, and is a guarantee for the manufacturing entity set to achieve the dual carbon goals, which is conducive to the precise control of major carbon emission sources and the effective implementation of various energy saving and carbon reduction measures. In related technologies, the allocation method based on historical intensity reduction is not applicable to the complex mechanical manufacturing industry. It does not take into account the differences in manufacturing entity category, carbon emission intensity, decoupling state, and dual carbon planning requirements of manufacturing entities, and cannot truly reflect the actual situation of the mechanical manufacturing industry. Below, a solution of the present disclosure will be introduced with a mechanical manufacturing entity as an example.

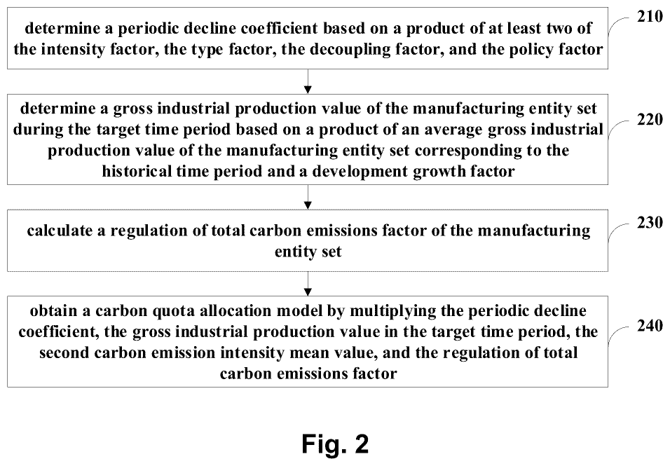

FIG. 2 is a flowchart of a carbon quota processing method according to other embodiments of the present disclosure.

In step 210, a periodic decline coefficient is determined based on a product of at least two of the intensity factor, the type factor, the decoupling factor, and the policy factor.

In some embodiments, the category of the target manufacturing entity comprises a first type entity, a second type entity, or a third type entity, wherein the carbon emission reduction capacity of the first type entity is greater than that of the second type entity, and the carbon emission reduction capacity of the second type entity is greater than that of the third type entity.

For example, the first type entity is an original equipment manufacturer company with a long process flow and great emission reduction potential; the second type entity is a component company with a short process flow and average emission reduction potential; the third type entity is a platform company with little potential to reduce emissions and no production.

In this embodiment, manufacturing entities are classified according to the types of their manufacturing processes. Manufacturing entities with similar process types have similar emission reduction potential and undertake emission reduction tasks with the same level of difficulty. Manufacturing entities with similar process types are classified into one category to complete the allocation of carbon quotas. Alternatively, manufacturing entities are classified according to the energy consumption intensity of the manufacturing entities, and influencing factors for carbon quota allocation are selected based on different levels of energy consumption intensity.

In some embodiments, the intensity factor is set to a first value in a case where the target manufacturing entity is the first type entity or the second type entity, and the second carbon emission intensity mean value of the target manufacturing entity is greater than the first carbon emission intensity mean value; the intensity factor is set to a second value greater than the first value in a case where the target manufacturing entity is the first type entity or the second type entity, and the second carbon emission intensity mean value of the target manufacturing entity is less than or equal to the first carbon emission intensity mean value;

and the intensity factor is set to a third value greater than the second value in a case where the target manufacturing entity is the third type entity.

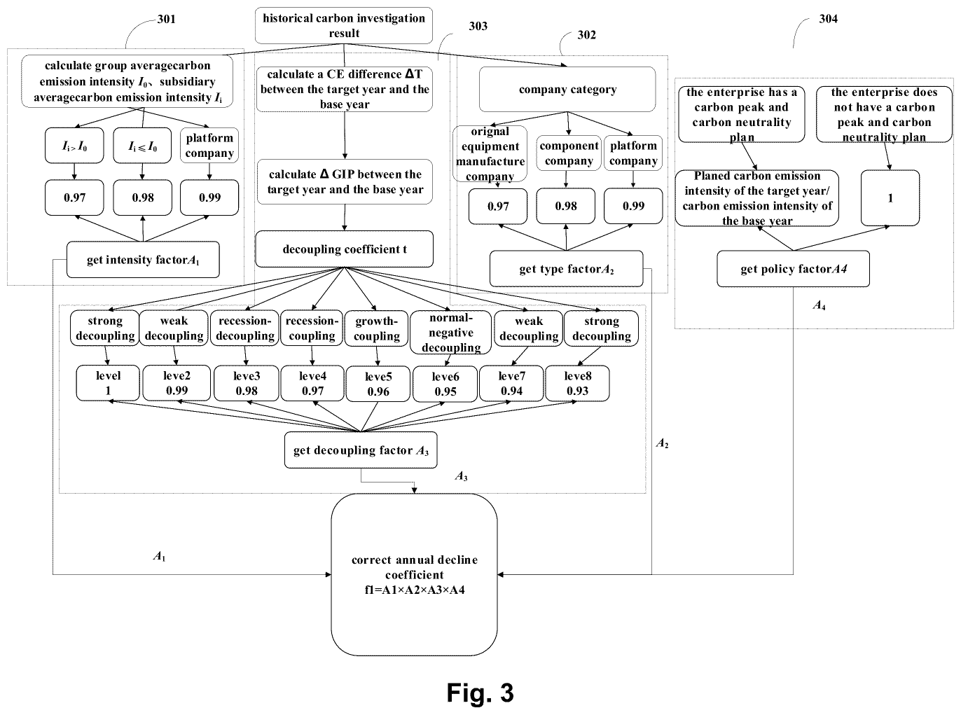

For example, as shown in FIG. 3, in block 301, a historical carbon emission intensity mean value I₀ of a group and historical carbon emission intensity mean value Iᵢ of a target enterprise are obtained based on the historical carbon investigation result of enterprises of the group. The intensity factor A₁ is corrected and assigned based on I₀ and Iᵢ. If the target enterprise is a platform company without a production workshop, the carbon emissions mainly come from everyday electricity consumption in the office, and the difficulty of emission reduction is relatively high. In this case, its intensity factor is defined separately, such as 0.99-1. If the target enterprise is an original equipment manufacturer company or component company, and Iᵢ>I₀, the intensity factor of the target enterprise is set to 0.97˜0.98; and if Iᵢ≤I₀, the intensity factor of the target enterprise is set to 0.98˜0.99.

The use of the intensity factor can effectively control the carbon emission intensity of each manufacturing entity in the manufacturing entity set, solve the problem of significant differences in carbon emission intensity among different manufacturing entities, thus better achieving the control goal of carbon emission intensity.

In some embodiments, the type factor is set to a fourth value in a case where the target manufacturing entity is the first type entity; the type factor is set to a fifth value greater than the fourth value in a case where the target manufacturing entity is the second type entity; and the type factor is set to a sixth value greater than the fifth value in a case where the target manufacturing entity is the third type entity.

For example, in block 302, the type factor A₂ is corrected and assigned based on the type of enterprise. If the target enterprise is an original equipment manufacturer company, the type factor of the target enterprise is set to 0.97˜0.98. If the target enterprise is a component company, the type factor of the target enterprise is set to 0.98˜0.99. If the target enterprise is a platform company, the type factor of the target enterprise is set to 0.99˜1.00.

By adopting the type factor, it is possible to effectively solve the problem of carbon quota allocation caused by different types, different production processes and emission reduction capabilities, and different dual carbon planning of manufacturing entities.

In some embodiments, a first parameter is obtained by calculating a ratio of the carbon emission change of the target manufacturing entity during the first time period relative to the second time period to a carbon emission during the second time period; a second parameter is obtained by calculating a ratio of a gross industrial production change of the target manufacturing entity during the first time period relative to the second time period to a gross industrial production change during the second time period; and a decoupling coefficient is obtained based on a ratio of the first parameter to the second parameter; and the decoupling factor is set based on the decoupling coefficient.

For example, the carbon emission decoupling coefficient t is the result of dividing the annual growth rate of an enterprise's total carbon emissions by the annual growth rate of the enterprise's gross industrial production, and is calculated as a relative indicator according to the following formula:

$$t = \frac{{ΔCO}_{2} / {CO}_{{2}_{0}}}{Δ GIP / {GIP}_{0}} ,$$

where ΔCO₂ is the carbon emission change relative to the base year, CO_{2 0} is the carbon emissions in the base year, ΔGIP is the gross industrial production change relative to the base year, and GIP₀ is the gross industrial production in the base year. As shown in Table 2, the decoupling coefficient t of the enterprise is analyzed to obtain a corresponding decoupling state.

TABLE 2
Decoupling State

| | | De- | | |
|---|---|---|---|---|
| | | coupling | De- | |
| | | coefficient | coupling | |
| ΔCO₂ | ΔGIP | t | state | Meanings |
| −decrease | +increase | T < 0 | strong | increased output, |
| | | | decoupling | reduced carbon |
| | | | | emissions, ideal |
| +slow | +fast | 0 ≤ t < 0.8 | weak | the growth rate of |
| increase | increase | | decoupling | output is higher |
| | | | | than the growth |
| | | | | rate of carbon |
| | | | | emissions, good |
| −fast | −slow | t > 1.2 | recession- | the rate of output |
| decrease | decrease | | decoupling | reduction is less |
| | | | | than the rate of |
| | | | | carbon emission |
| | | | | reduction, allowed |
| +same | +same | 0.8 < t < 1.2 | growth- | the output and carbon |
| increase | increase | | coupling | emissions increase |
| | | | | synchronously, |
| | | | | undesirable |
| −same | −same | 0.8 < t < 1.2 | recession- | the output and carbon |
| decrease | decrease | | coupling | emissions decrease |
| | | | | synchronously, allowed |
| +fast | +slow | t > 1.2 | growth- | the growth rate of |
| increase | increase | | negative | output is lower |
| | | | decoupling | than the growth rate |
| | | | | of carbon emissions, |
| | | | | undesirable |
| −slow | −fast | 0 < t < 0.8 | weak | the rate of |
| decrease | decrease | | negative | output reduction |
| | | | decoupling | is higher than |
| | | | | the rate of carbon |
| | | | | emission reduction, |
| | | | | undesirable |
| +increase | −decrease | t < 0 | strong | reduced output, |
| | | | negative | increased carbon |
| | | | decoupling | emissions, worst |

If the decoupling coefficient of the enterprise is t<0, ΔCO₂ is a negative value, and ΔGIP is a positive value, then the enterprise is in a strong decoupling state; if the decoupling coefficient of the enterprise is 0≤t<0.8, ΔCO₂ is a positive value, and ΔGIP is a positive value, then the enterprise is in a weak decoupling state; if the decoupling coefficient of the enterprise is t>1.2, ΔCO₂ is a negative value, and ΔGIP is a negative value, then the enterprise is in a recession-decoupling state; if the decoupling coefficient of the enterprise is 0.8<t<1.2, ΔCO₂ is a positive value, and ΔGIP is a positive value, then the enterprise is in an growth-coupling state; if the decoupling coefficient of the enterprise is 0.8<t<1.2, ΔCO₂ is a negative value, and ΔGIP is a negative value, then the enterprise is in a recession-coupling state; if the decoupling coefficient of the enterprise is t>1.2, ΔCO₂ is a positive value, and ΔGIP is a positive value, then the enterprise is in a growth-negative decoupling state; if the decoupling coefficient of the enterprise is 0<t<0.8, ΔCO₂ is a negative value, and ΔGIP is a negative value, then the enterprise is in a weak negative decoupling state; if the decoupling coefficient of the enterprise is t<0, ΔCO₂ is a positive value, and ΔGIP is a negative value, then the enterprise is in a strong negative decoupling state.

On the basis of determining the decoupling coefficient and state, the decoupling factor of the enterprise is further modified. For platform companies without output values, due to their small space and high pressure for energy conservation and emission reduction, the decoupling factor and corresponding level are calculated according to a weak decoupling state, which is shown in Table 3 and block 303 of FIG. 3.

TABLE 3
Classification and assignment of decoupling state

| Decoupling | Decoupling | Decoupling | Corresponding |
|---|---|---|---|
| coefficient t | state | factor A₂ | level |
| T < 0 | strong decoupling | 1 | level 1 |
| 0 ≤ t < 0.8 | weak decoupling | 0.99~1.00 | level 2 |
| t > 1.2 | recession-decoupling | 0.98~0.99 | level 3 |
| 0.8 < t < 1.2 | growth-coupling | 0.97~0.98 | level 4 |
| 0.8 < t < 1.2 | recession-coupling | 0.96~0.97 | level 5 |
| t > 1.2 | growth-negative | 0.95~0.96 | level 6 |
| | decoupling | | |
| 0 < t < 0.8 | weak negative | 0.94~0.95 | level 7 |
| | decoupling | | |
| T < 0 | strong negative | 0.93~0.94 | level 8 |
| | decoupling | | |

In some embodiments, the decoupling factor is set to a seventh value, in a case where the decoupling coefficient is less than 0, the carbon emission change is less than 0, and the gross industrial production change is greater than 0. This indicates that the enterprise is in a strong decoupling state, and the decoupling factor is set to 1.

The decoupling factor is set to an eighth value less than the seventh value, in a case where the decoupling coefficient is greater than or equal to 0 and less than a first threshold value, the carbon emission change is greater than or equal to 0, and the gross industrial production change is greater than 0. This indicates that the enterprise is in a weak decoupling state, and the decoupling factor is set to 0.99˜1.00.

The decoupling factor is set to a ninth value less than the eight value, in a case where the decoupling coefficient is greater than a second threshold value, the carbon emission change is less than 0, and the gross industrial production change is less than 0. This indicates that the enterprise is in a recession-decoupling state, and the decoupling factor is set to 0.98˜0.99.

The decoupling factor is set to a tenth value less than the ninth value, in a case where the decoupling coefficient is greater than the first threshold value and less than the second threshold value, the carbon emission change is greater than 0, and the gross industrial production change is greater than 0. This indicates that the enterprise is in a growth-coupling state, and the decoupling factor is set to 0.97˜0.98.

The decoupling factor is set to an eleventh value less than the tenth value, in a case where the decoupling coefficient is greater than the first threshold value and less than the second threshold value, the carbon emission change is less than 0, and the gross industrial production change is less than 0. This indicates that the enterprise is in a recession-coupling state, and the decoupling factor is set to 0.96˜0.97.

The decoupling factor is set to a twelfth value less than the eleventh value, in a case where the decoupling coefficient is greater than the second threshold value, the carbon emission change is greater than 0, and the gross industrial production change is greater than 0. This indicates that the enterprise is in a growth-negative decoupling state, and the decoupling factor is set to 0.95˜0.96.

The decoupling factor is set to a thirteenth value less than the twelfth value, in a case where the decoupling coefficient is greater than 0 and less than the first threshold value, the carbon emission change is less than 0, and the gross industrial production change is less than 0. This indicates that the enterprise is in a weak negative decoupling state, and the decoupling factor is set to 0.94˜0.95.

The decoupling factor is set to a fourteenth value less than the thirteenth value, in a case where the decoupling coefficient is less than 0, the carbon emission change is greater than 0, and the gross industrial production change is less than 0. This indicates that the enterprise is in a strong negative decoupling state, and the decoupling factor is set to 0.93˜0.94.

The decoupling factor can achieve reasonable control of the decoupling status of each manufacturing entity in the manufacturing entity set, effectively solving the problem of significant differences in the decoupling status between carbon emissions and gross industrial production of each manufacturing entity, balancing the relationship between environmental protection and development, and achieving positive decoupling development.

In some embodiments, a policy factor is determined based on a ratio of a carbon emission intensity of the target manufacturing entity during the target time period to a carbon emission intensity in the second time period, in a case that the target manufacturing entity is determined to have a carbon emission goal based on the carbon emission planning parameter; and the policy factor is set to 1, in a case that the target manufacturing entity is determined to not have a carbon emission goal.

For example, as shown in block 304 of FIG. 3, the policy factor A₄ is corrected and assigned based on the carbon emission intensity reduction ratio in a target year relative to the base year specified in the enterprise's carbon peak and carbon neutrality plan. If there is no planning requirement, it can be set to 1.

An annual decline coefficient f1 of the target enterprise is f₁=A₁₌×A₂×A₃×A₄.

In the above step, starting from the actual situation of the manufacturing enterprise, the annual decline coefficient in the historical intensity decline method is gradually adjusted and assigned to obtain the annual decline coefficient for the target year.

In step 220, a gross industrial production value of the manufacturing entity set during the target time period is determined based on a product of an average gross industrial production value of the manufacturing entity set corresponding to the historical time period and a development growth factor.

For example, the development growth factor B=a ratio of the planed group gross industrial production in the target year to the gross industrial production in the base year. Based on the carbon inventory data of the enterprise set in historical years, a total gross industrial production Q of the entire enterprise set in the target year is evaluated by multiplying an average production Q₀ of the enterprise set of all historical years by a development growth factor B of the enterprise set.

In this step, the gross industrial production is corrected by the development growth factor to obtain a carbon quota allocation in the target year.

By correcting the annual decline coefficient x the gross industrial production in the target year x the average carbon intensity of the target enterprise, the carbon quota of the target enterprise can be obtained. For example, the carbon quota Tᵢ for the target enterprise can obtained using the formula Tᵢ=f₁×Q×Iᵢ=A₁×A₂×A₃×A₄×Q₀×B×Iᵢ, where i represents the i-th target enterprise. Of course, according to the different situations of enterprise sets, various influencing factors can be reduced and adjusted to ultimately achieve scientific and reasonable carbon quota allocation.

By considering the type factor, policy factor, and development growth factor, comprehensive and multi-level selection and matching of carbon emission influencing factors can be achieved, helping manufacturing entities to deeply explore their carbon reduction potential.

In step 230, a regulation of total carbon emissions factor of the manufacturing entity set is calculated.

In some embodiments, a sum of carbon quotas of the multiple manufacturing entities during the target time period is calculated to obtain a total carbon quota allocation of the manufacturing entity set; the regulation of total carbon emissions factor is obtained based on a ratio of a total carbon emission target value of the manufacturing entity set during the target time period to the total carbon quota allocation of the manufacturing entity set.

For example, by summing up the carbon quota allocation results of the various enterprises, a total amount of carbon quota allocation for the enterprise set is obtained, which is then divided by the total carbon emission target value of the enterprise set to obtain the regulation of total carbon emissions factor C. This regulation of total carbon emissions factor C can be used to reduce the difference between the total allocation amount and the target value, thereby obtaining a carbon quota allocation that is closer to the actual situation of the manufacturing entity, completing the final revision of the carbon quota allocation plan, and effectively achieving the control requirements of the total carbon emission. The total carbon emission target value, for example, is a preset value or a target value predicted based on a certain algorithm, which is not specifically limited in this disclosure.

In step 240, a carbon quota allocation model is obtained by multiplying the periodic decline coefficient, the gross industrial production value in the target time period, the second carbon emission intensity mean value, and the regulation of total carbon emissions factor.

For example, the carbon quota allocation model is T_{i final}=A₁×A₂×A₃×A₄₌×Q₀×B×Iᵢ×C.

In the above embodiment, the periodic decline coefficient in the historical intensity decline method is gradually corrected and assigned using the intensity factor A1 indicating different historical carbon emission intensities among different manufacturing entities, the type factor A₂ representing different categories of manufacturing entities, the decoupling factor A₃ representing different decoupling states between historical carbon emissions and total gross industrial production values of the manufacturing entities, and the policy factor A₄ representing a planed decline requirement of the manufacturing entity set to obtain a decline coefficient in the target time period; the gross industrial production is corrected using the development growth factor to obtain a carbon quota allocation value in the target time period; finally, carbon quota allocation result is further adjusted by correcting the difference between the total carbon quota allocation and the total carbon emission goal of the set using the regulation of total carbon emissions factor, such that the allocation result is more consistent with the total carbon emission goal to obtain the final carbon quota allocation scheme, which is conducive to achieving the goal of controlling both the total carbon quota allocation and the carbon emission intensity of the manufacturing entity set, and has strong technical promotion in achieving dual control of carbon emissions, precise emission reduction, and effective carbon reduction for manufacturing entities.

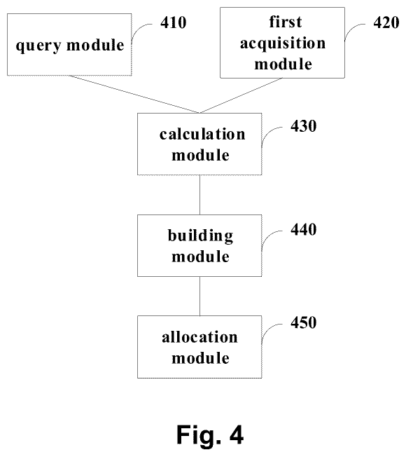

FIG. 4 is a schematic structure diagram of a carbon quota processing system according to some embodiments of the present disclosure, which comprises a query module 410, a first acquisition module 420, a calculation module 430, a building module 440, and an allocation module 450.

The query module 410 is configured to determine a target manufacturing entity and search for historical carbon inventory data of manufacturing entities within a manufacturing entity set to which the target manufacturing entity belongs.

In some embodiments, the query module 410 searches a database for historical carbon inventory data of multiple manufacturing entities within a manufacturing entity set to which the target manufacturing entity belongs in response to a carbon quota allocation request sent by the target manufacturing entity.

The first acquisition module 420 is configured to obtain a carbon emission planning parameter of the target manufacturing entity during a target time period.

In some embodiments, it can be determined whether the target enterprise has a dual carbon plan based on the carbon emission planning parameter. If the target enterprise does not have a dual carbon plan, a value related to the carbon emission planning parameter is set to 1.

The calculation module 430 is configured to calculate influencing factors that influence the balance between environmental protection and development of the target manufacturing entity based on the historical carbon inventory data and the carbon emission planning parameter.

In some embodiments, enterprises have different historical carbon emission intensities, different enterprise categories, different production processes and emission reduction capacities, the different decoupling states between carbon emissions and economic growth, and different requirements for dual carbon planning. Therefore, the influencing factors that affect the balance of environmental protection and development of enterprises may comprise an intensity factor, a type factor, a decoupling factor, a policy factor, etc.

In some embodiments, the calculation module 430 calculates a first carbon emission intensity mean value of the manufacturing entity set corresponding to a historical time period, a second carbon emission intensity mean value of the target manufacturing entity corresponding to the historical time period, a carbon emission change and a gross industrial production change of the target manufacturing entity during a first time period within the historical time period relative to a second time period prior to the first time period, and a type of the target manufacturing entity based on the historical carbon inventory data; and calculates the influencing factors that influence the balance between environmental protection and development of the target manufacturing entity based on the first carbon emission intensity mean value, the second carbon emission intensity mean value, the carbon emission change, the gross industrial production change, the category of the target manufacturing entity, and the carbon emission planning parameter.

For example, the first carbon emission intensity mean value is determined based on a ratio of a sum of carbon emissions of multiple manufacturing entities in the historical carbon inventory data to a sum of gross industrial production values of the multiple manufacturing entities in the historical time period.

For another example, the second carbon emission intensity mean value is determined based on a ratio of a sum of carbon emissions of the target manufacturing entity during the historical time period in the historical carbon inventory data to a sum of the GIP values of the target manufacturing entity during the historical time period.

In some embodiments, the type of the target manufacturing entity comprises a first type entity, a second type entity, or a third type entity, wherein the carbon emission reduction capacity of the first type entity is greater than that of the second type entity, and the carbon emission reduction capacity of the second type entity is greater than that of the third type entity.

The calculation module 430 sets the intensity factor to a first value in a case where the target manufacturing entity is the first type entity or the second type entity, and the second carbon emission intensity mean value of the target manufacturing entity is greater than the first carbon emission intensity mean value; the calculation module 430 sets the intensity factor to a second value greater than the first value in a case where the target manufacturing entity is the first type entity or the second type entity, and the second carbon emission intensity mean value of the target manufacturing entity is less than or equal to the first carbon emission intensity mean value; and the calculation module 430 sets the intensity factor to a third value greater than the second value in a case where the target manufacturing entity is a third type entity.

The calculation module 430 sets the type factor to a fourth value in a case where the target manufacturing entity is the first type entity; the calculation module 430 sets the type factor to a fifth value greater than the fourth value in a case where the target manufacturing entity is the second type entity; and the calculation module 430 sets the type factor to a sixth value greater than the fifth value in a case where the target manufacturing entity is the third type entity.

The calculation module 430 is configured to obtain a first parameter by calculating a ratio of the carbon emission change of the target manufacturing entity during the first time period relative to the second time period to a carbon emission during the second time period; obtain a second parameter by calculating a ratio of a gross industrial production change of the target manufacturing entity during the first time period relative to the second time period to a gross industrial production change during the second time period; determine a decoupling coefficient based on a ratio of the first parameter to the second parameter; and set the decoupling factor based on the decoupling coefficient.

For example, the decoupling factor is set to a seventh value, in a case where the decoupling coefficient is less than 0, the carbon emission change is less than 0, and the gross industrial production change is greater than 0; the decoupling factor is set to an eighth value less than the seventh value, in a case where the decoupling coefficient is greater than or equal to 0 and less than a first threshold value, the carbon emission change is greater than or equal to 0, and the gross industrial production change is greater than 0; the decoupling factor is set to a ninth value less than the eight value, in a case where the decoupling coefficient is greater than a second threshold value, the carbon emission change is less than 0, and the gross industrial production change is less than 0; the decoupling factor is set to a tenth value less than the ninth value, in a case where the decoupling coefficient is greater than the first threshold value and less than the second threshold value, the carbon emission change is greater than 0, and the gross industrial production change is greater than 0; the decoupling factor is set to an eleventh value less than the tenth value, in a case where the decoupling coefficient is greater than the first threshold value and less than the second threshold value, the carbon emission change is less than 0, and the gross industrial production change is less than 0; the decoupling factor is set to a twelfth value less than the eleventh value, in a case where the decoupling coefficient is greater than the second threshold value, the carbon emission change is greater than 0, and the gross industrial production change is greater than 0; the decoupling factor is set to a thirteenth value less than the twelfth value, in a case where the decoupling coefficient is greater than 0 and less than the first threshold value, the carbon emission change is less than 0, and the gross industrial production change is less than 0; and the decoupling factor is set to a fourteenth value less than the thirteenth value, in a case where the decoupling coefficient is less than 0, the carbon emission change is greater than 0, and the gross industrial production change is less than 0.

The calculation module 430 is configured to determine the policy factor based on a ratio of a carbon emission intensity of the target manufacturing entity during the target time period to a carbon emission intensity during the second time period based on the carbon emission planning parameter, in a case that the target manufacturing entity is determined to have a carbon emission goal based on the carbon emission planning parameter; and set the policy factor to 1, in a case that the target manufacturing entity is determined to not have a carbon emission goal.

The building module 440 is configured to build a carbon quota allocation model based on the influencing factors.

In some embodiments, the building module 440 determines a periodic decline coefficient based on a product of at least two of the intensity factor, the type factor, the decoupling factor, and the policy factor; determines a gross industrial production value of the manufacturing entity set during the target time period based on a product of an average gross industrial production value of the manufacturing entity set corresponding to the historical time period and the development growth factor; and obtains the carbon quota allocation model by multiplying the periodic decline coefficient, the gross industrial production value during the target time period, and the second carbon emission intensity mean value.

In some embodiments, the building module 440 calculates a regulation of total carbon emissions factor for the manufacturing entity set, and obtains a carbon quota allocation model by multiplying the periodic decline coefficient, the gross industrial production value in the target time period, the second carbon emission intensity mean value, and the regulation of total carbon emissions factor.

Calculating a regulation of total carbon emissions factor for the manufacturing entity set comprises: calculating a sum of carbon quotas of the multiple manufacturing entities during the target time period to obtain a total carbon quota allocation of the manufacturing entity set; obtaining the regulation of total carbon emissions factor based on a ratio of a total carbon emission target value of the manufacturing entity set during the target time period to the total carbon quota allocation of the manufacturing entity set.

The allocation module 450 is configured to allocate a carbon quota during the target time period to the target manufacturing entity based on the carbon quota allocation model.

For example, with the carbon quota allocation model, a carbon quota allocated to the target enterprise can be calculated, and the carbon quota data can be sent to a client of each enterprise, so that each enterprise can improve its equipment parameters or processes based on the carbon quota data to match the carbon emission during the target time period with the carbon quota data.

In the above embodiment, based on historical carbon inventory data and a carbon emission planning parameter, influencing factors affecting the balance between environmental protection and development of the target manufacturing entity are calculated, and a carbon quota allocation model is constructed to achieve the scientific and reasonable carbon quota allocation for the manufacturing entity, thereby enabling the manufacturing entity to achieve a balance between environmental protection and development, so that development and growth are achieved on the basis of guaranteeing environmental protection.

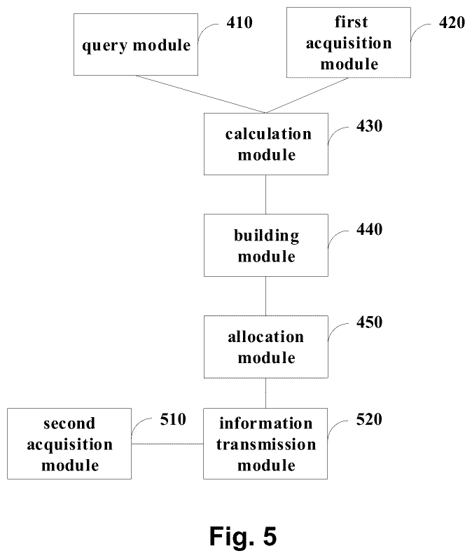

In some embodiments of the present disclosure, as shown in FIG. 5, the carbon quota processing system further comprises a second acquisition module 510 and an information transmission module 520.

The second acquisition module 510 is configured to obtain a carbon emission of the target manufacturing entity during a target time period. The information transmission module 520 is configured to send a prompt message to a client of the target manufacturing entity, in a case where the carbon emission of the target manufacturing entity during the target time period does not match the allocated carbon quota.

In this embodiment, the carbon quota processing system compares the carbon emission and the carbon quota, and promptly sends a prompt message to a client of the manufacturing entity, which is helpful for the manufacturing entity to detect problems in a timely manner, enabling the manufacturing entity to improve equipment parameters or processes, or increase productivity, and thereby further meeting the requirement of balancing environmental protection and development.

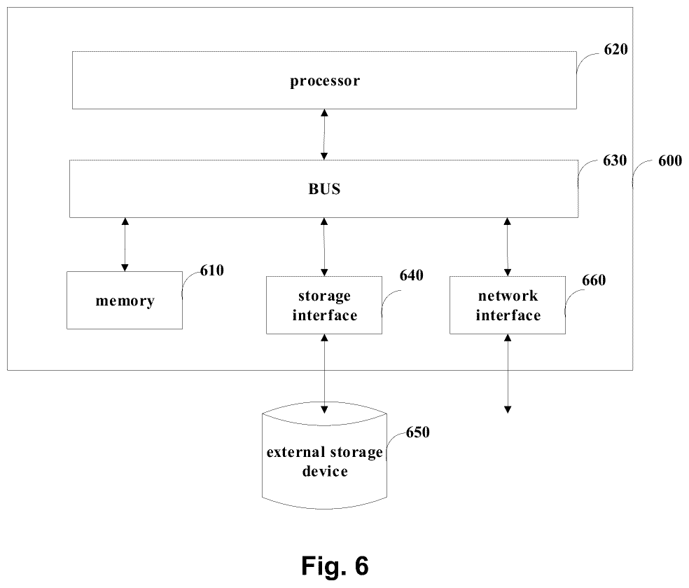

FIG. 6 is a structure diagram of a carbon quota processing system according to still other embodiments of the present disclosure. The carbon quota processing system 600 comprises a memory 610 and a processor 620. Wherein, the memory 610 may be a magnetic disk, flash memory or any other non-volatile storage medium. The memory 610 is used to store instructions of the above embodiment. The processor 620 is coupled to the memory 610 and may be implemented as one or more integrated circuits, such as a microprocessor or microcontroller. The processor 620 is used to execute the instructions stored in the memory.

In some embodiments, the processor 620 is coupled to the memory 610 via a bus 630. The medical system 600 may be further connected to an external storage device 650 through a storage interface 640 to access external data, and may be further connected to a network or another computer system (not shown) through a network interface 660, which will not be described in detail herein.

In this embodiment, by storing data instructions in a memory and processing the above instructions by a processor, scientific carbon quota allocation is achieved, and the need for balance between environmental protection and development of a manufacturing enterprise can be met.

In other embodiments, there is provided a computer-readable storage medium stored thereon computer program instructions that, when executed by a processor, implement the steps of the method of the above embodiment. One skilled in the art should understand that, the embodiments of the present disclosure may be provided as a method, an apparatus, or a computer program product. Therefore, embodiments of the present disclosure can take the form of an entirely hardware embodiment, an entirely software embodiment or an embodiment containing both hardware and software elements. Moreover, the present disclosure may take the form of a computer program product embodied on one or more computer-usable non-transitory storage media (including but not limited to disk storage, CD-ROM, optical storage device, etc.) having computer-usable program code embodied therein.

The present disclosure is described with reference to flowcharts and/or block diagrams of methods, apparatuses (systems) and computer program products according to embodiments of the present disclosure. It should be understood that each process and/or block in the flowcharts and/or block diagrams, and combinations of the processes and/or blocks in the flowcharts and/or block diagrams may be implemented by computer program instructions. The computer program instructions may be provided to a processor of a general purpose computer, a special purpose computer, an embedded processor, or other programmable data processing apparatus to generate a machine such that the instructions executed by a processor of a computer or other programmable data processing apparatus to generate means implementing the functions specified in one or more flows of the flowcharts and/or one or more blocks of the block diagrams.

The computer program instructions may also be stored in a computer readable storage device capable of directing a computer or other programmable data processing apparatus to operate in a specific manner such that the instructions stored in the computer readable storage device produce an article of manufacture including instruction means implementing the functions specified in one or more flows of the flowcharts and/or one or more blocks of the block diagrams.

These computer program instructions can also be loaded onto a computer or other programmable device to perform a series of operation steps on the computer or other programmable device to generate a computer-implemented process such that the instructions executed on the computer or other programmable device provide steps implementing the functions specified in one or more flows of the flowcharts and/or one or more blocks of the block diagrams.

Heretofore, the present disclosure has been described in detail. In order to avoid obscuring the concepts of the present disclosure, some details known in the art are not described. Based on the above description, those skilled in the art can understand how to implement the technical solutions disclosed herein.

The method and apparatus of the present disclosure may be implemented in many ways. For example, the method and apparatus of the present disclosure may be implemented by software, hardware, firmware, or any combination of software, hardware, and firmware. The above sequence of steps of the method is merely for the purpose of illustration, and the steps of the method of the present disclosure are not limited to the above-described specific order unless otherwise specified. In addition, in some embodiments, the present disclosure may also be implemented as programs recorded in a recording medium, which include machine-readable instructions for implementing the method according to the present disclosure. Thus, the present disclosure also covers a recording medium storing programs for executing the method according to the present disclosure.

Although some specific embodiments of the present disclosure have been described in detail by way of example, those skilled in the art should understand that the above examples are only for the purpose of illustration and are not intended to limit the scope of the present disclosure. It should be understood by those skilled in the art that the above embodiments may be modified without departing from the scope and spirit of the present disclosure. The scope of the disclosure is defined by the following claims.

What is claimed is:

1. A carbon quota processing method, comprising:
determining a target manufacturing entity and searching for historical carbon inventory data of manufacturing entities within a manufacturing entity set to which the target manufacturing entity belongs;
obtaining a carbon emission planning parameter of the target manufacturing entity during a target time period;
calculating influencing factors that influence the balance between environmental protection and development of the target manufacturing entity based on the historical carbon inventory data and the carbon emission planning parameter;
building a carbon quota allocation model based on the influencing factors; and
allocating a carbon quota during the target time period to the target manufacturing entity based on the carbon quota allocation model.

2. The carbon quota processing method according to claim 1, further comprising:
obtaining a carbon emission of the target manufacturing entity during the target time period; and
sending a prompt message to a client of the target manufacturing entity, in a case where the carbon emission of the target manufacturing entity during the target time period does not match the allocated carbon quota.

3. The carbon quota processing method according to claim 1, wherein calculating influencing factors that influence the balance between environmental protection and development of the target manufacturing entity comprises:
calculating a first carbon emission intensity mean value of the manufacturing entity set corresponding to a historical time period, a second carbon emission intensity mean value of the target manufacturing entity corresponding to the historical time period, a carbon emission change and a gross industrial production change of the target manufacturing entity during a first time period within the historical time period relative to a second time period prior to the first time period, and a type of the target manufacturing entity, based on the historical carbon inventory data; and
calculating the influencing factors that influence the balance between environmental protection and development of the target manufacturing entity based on the first carbon emission intensity mean value, the second carbon emission intensity mean value, the carbon emission change, the gross industrial production change, the category of the target manufacturing entity, and the carbon emission planning parameter.

4. The carbon quota processing method according to claim 3, wherein the influencing factors comprise a development growth factor and at least two of an intensity factor, a type factor, a decoupling factor and a policy factor, wherein building the carbon quota allocation model comprises:
determining a periodic decline coefficient based on a product of at least two of the intensity factor, the type factor, the decoupling factor, and the policy factor;
determining a gross industrial production value of the manufacturing entity set during the target time period based on a product of an average gross industrial production value of the manufacturing entity set corresponding to the historical time period and the development growth factor; and
obtaining the carbon quota allocation model by multiplying the periodic decline coefficient, the gross industrial production value during the target time period, and the second carbon emission intensity mean value.

5. The carbon quota processing method according to claim 4, further comprising:
calculating a regulation of total carbon emissions factor for the manufacturing entity set,
wherein obtaining the carbon quota allocation model further comprises:
obtaining the carbon quota allocation model by multiplying the periodic decline coefficient, the gross industrial production value during the target time period, the second carbon emission intensity mean value, and the regulation of total carbon emissions factor.

6. The carbon quota processing method according to claim 5, wherein calculating the regulation of total carbon emissions factor for the manufacturing entity set comprises:
calculating a sum of carbon quotas of the multiple manufacturing entities during the target time period to obtain a total carbon quota allocation of the manufacturing entity set; and
obtaining the regulation of total carbon emissions factor based on a ratio of a total carbon emission target value of the manufacturing entity set during the target time period to the total carbon quota allocation of the manufacturing entity set.

7. The carbon quota processing method according to claim 4, wherein the type of the target manufacturing entity comprises a first type entity, a second type entity, or a third type entity, wherein the carbon emission reduction capacity of the first type entity is greater than that of the second type entity, and the carbon emission reduction capacity of the second type entity is greater than that of the third type entity.

8. The carbon quota processing method according to claim 7, wherein calculating the intensity factor comprises:
setting the intensity factor to a first value in a case where the target manufacturing entity is the first type entity or the second type entity, and the second carbon emission intensity mean value of the target manufacturing entity is greater than the first carbon emission intensity mean value;
setting the intensity factor to a second value greater than the first value in a case where the target manufacturing entity is the first type entity or the second type entity, and the second carbon emission intensity mean value of the target manufacturing entity is less than or equal to the first carbon emission intensity mean value; and
setting the intensity factor to a third value greater than the second value in a case where the target manufacturing entity is the third type entity.

9. The carbon quota processing method according to claim 7, wherein calculating the type factor comprises:
setting the type factor to a fourth value in a case where the target manufacturing entity is the first type entity;
setting the type factor to a fifth value greater than the fourth value in a case where the target manufacturing entity is the second type entity; and
setting the type factor to a sixth value greater than the fifth value in a case where the target manufacturing entity is the third type entity.

10. The carbon quota processing method according to claim 4, wherein calculating the decoupling factor comprises:
obtain a first parameter by calculating a ratio of the carbon emission change of the target manufacturing entity during the first time period relative to the second time period to a carbon emission during the second time period;
obtain a second parameter by calculating a ratio of a gross industrial production change of the target manufacturing entity during the first time period relative to the second time period to a gross industrial production change during the second time period;
determining a decoupling coefficient based on a ratio of the first parameter to the second parameter; and
setting the decoupling factor based on the decoupling coefficient.

11. The carbon quota processing method according to claim 10, wherein setting the decoupling factor comprises:
setting the decoupling factor to a seventh value in a case where the decoupling coefficient is less than 0, and the carbon emission change is less than 0, and the gross industrial production change is greater than 0;
setting the decoupling factor to an eighth value less than the seventh value, in a case where the decoupling coefficient is greater than or equal to 0 and less than a first threshold value, the carbon emission change is greater than or equal to 0, and the gross industrial production change is greater than 0;
setting the decoupling factor to a ninth value less than the eight value, in a case where the decoupling coefficient is greater than a second threshold value, the carbon emission change is less than 0, and the gross industrial production change is less than 0;
setting the decoupling factor to a tenth value less than the ninth value, in a case where the decoupling coefficient is greater than the first threshold value and less than the second threshold value, the carbon emission change is greater than 0, and the gross industrial production change is greater than 0;
setting the decoupling factor to an eleventh value less than the tenth value, in a case where the decoupling coefficient is greater than the first threshold value and less than the second threshold value, the carbon emission change is less than 0, and the gross industrial production change is less than 0;
setting the decoupling factor to a twelfth value less than the eleventh value, in a case where the decoupling coefficient is greater than the second threshold value, the carbon emission change is greater than 0, and the gross industrial production change is greater than 0;
setting the decoupling factor to a thirteenth value less than the twelfth value, in a case where the decoupling coefficient is greater than 0 and less than the first threshold value, the carbon emission change is less than 0, and the gross industrial production change is less than 0; and
setting the decoupling factor to a fourteenth value less than the thirteenth value, in a case where the decoupling coefficient is less than 0, the carbon emission change is greater than 0, and the gross industrial production change is less than 0.

12. The carbon quota processing method according to claim 4, wherein calculating the policy factor comprises:
determining the policy factor based on a ratio of a carbon emission intensity of the target manufacturing entity during the target time period to a carbon emission intensity during the second time period, in a case that the target manufacturing entity is determined to have a carbon emission goal based on the carbon emission planning parameter; and
setting the policy factor to 1, in a case that the target manufacturing entity is determined to not have a carbon emission goal.

13. The carbon quota processing method according to claim 3, wherein calculating the first carbon emission intensity mean value of the manufacturing entity set corresponding to the historical time period comprises:
determining the first carbon emission intensity mean value based on a ratio of a sum of carbon emissions of multiple manufacturing entities in the historical carbon inventory data to a sum of gross industrial production values of the multiple manufacturing entities during the historical time period.

14. The carbon quota processing method according to claim 3, wherein calculating the second carbon emission intensity mean value of the target manufacturing entity corresponding to the historical time period comprises:
determining the second carbon emission intensity mean value based on a ratio of a sum of carbon emissions of the target manufacturing entity during the historical time period in the historical carbon inventory data to a sum of the gross industrial production values of the target manufacturing entity during the historical time period.

15. A carbon quota processing system, comprising:
a memory; and
a processor coupled to the memory, the processor configured to, based on instructions stored in the memory, carry out a carbon quota processing method, comprising:
determining a target manufacturing entity and searching for historical carbon inventory data of manufacturing entities within a manufacturing entity set to which the target manufacturing entity belongs;
obtaining a carbon emission planning parameter of the target manufacturing entity during a target time period;
calculating influencing factors that influence the balance between environmental protection and development of the target manufacturing entity based on the historical carbon inventory data and the carbon emission planning parameter;
building a carbon quota allocation model based on the influencing factors; and
allocating a carbon quota during the target time period to the target manufacturing entity based on the carbon quota allocation model.

16. The carbon quota processing system according to claim 15, wherein the carbon quota processing method, further comprises:
obtaining a carbon emission of the target manufacturing entity during the target time period; and
sending a prompt message to a client of the target manufacturing entity, in a case where the carbon emission of the target manufacturing entity during the target time period does not match the allocated carbon quota.

17. The carbon quota processing system according to claim 15, wherein calculating influencing factors that influence the balance between environmental protection and development of the target manufacturing entity comprises:
calculating a first carbon emission intensity mean value of the manufacturing entity set corresponding to a historical time period, a second carbon emission intensity mean value of the target manufacturing entity corresponding to the historical time period, a carbon emission change and a gross industrial production change of the target manufacturing entity during a first time period within the historical time period relative to a second time period prior to the first time period, and a type of the target manufacturing entity, based on the historical carbon inventory data; and
calculating the influencing factors that influence the balance between environmental protection and development of the target manufacturing entity based on the first carbon emission intensity mean value, the second carbon emission intensity mean value, the carbon emission change, the gross industrial production change, the category of the target manufacturing entity, and the carbon emission planning parameter.

18. A non-transitory computer-readable storage medium stored thereon computer program instructions that, when executed by a processor, implement a carbon quota processing method, comprising:
determining a target manufacturing entity and searching for historical carbon inventory data of manufacturing entities within a manufacturing entity set to which the target manufacturing entity belongs;
obtaining a carbon emission planning parameter of the target manufacturing entity during a target time period;
calculating influencing factors that influence the balance between environmental protection and development of the target manufacturing entity based on the historical carbon inventory data and the carbon emission planning parameter;
building a carbon quota allocation model based on the influencing factors; and
allocating a carbon quota during the target time period to the target manufacturing entity based on the carbon quota allocation model.

19. The non-transitory computer-readable storage medium according to claim 18, wherein the carbon quota processing method, further comprises:
obtaining a carbon emission of the target manufacturing entity during the target time period; and
sending a prompt message to a client of the target manufacturing entity, in a case where the carbon emission of the target manufacturing entity during the target time period does not match the allocated carbon quota.

20. The non-transitory computer-readable storage medium according to claim 18, wherein calculating influencing factors that influence the balance between environmental protection and development of the target manufacturing entity comprises:
calculating a first carbon emission intensity mean value of the manufacturing entity set corresponding to a historical time period, a second carbon emission intensity mean value of the target manufacturing entity corresponding to the historical time period, a carbon emission change and a gross industrial production change of the target manufacturing entity during a first time period within the historical time period relative to a second time period prior to the first time period, and a type of the target manufacturing entity, based on the historical carbon inventory data; and
calculating the influencing factors that influence the balance between environmental protection and development of the target manufacturing entity based on the first carbon emission intensity mean value, the second carbon emission intensity mean value, the carbon emission change, the gross industrial production change, the category of the target manufacturing entity, and the carbon emission planning parameter.
